(19) United States
(12) Patent Application Publication
(10) Pub. No.: US 2026/0364727 A1
(43) Pub. Date: Nov. 19, 2026

(54) COLLET FOR COOLING CUTTER

(71) Applicant: SHIN-YAIN INDUSTRIAL CO., LTD., Taichung City (TW)

(72) Inventor: PEN HUNG CHEN, Taichung City (TW)

(73) Assignee: SHIN-YAIN INDUSTRIAL CO., LTD., Taichung City (TW)

(21) Appl. No.: 19/211,626

(22) Filed: May 19, 2025

(51) Int. Cl. B23Q 11/10

(52) U.S. Cl. CPC B23Q 11/1023

(57) ABSTRACT

A collet has a collet body, at least one groove, and at least one channel. The collet body has a central axis, a through hole extending along the central axis, a plurality of front slots, and a plurality of rear slots fluidly communicating with the groove and the channel. Each front slot extends from a front end toward a rear end of the collet body. Each rear slot extends from the rear end toward the front end of the collet body. Each groove is defined in an inner surface of the through hole, and extends from the front end toward the rear end of the collet body. Each channel separates from the through hole, extends from the front end toward the rear end of the collet body, and inclines toward the central axis and the front end.

### BACKGROUND OF THE INVENTION

### 1. Field of the Invention

The present invention relates to an accessory of a machining apparatus, and more particularly to a collet for cooling a cutter via various pathways.

### 2. Description of Related Art

A collet is a component used to fix a cutter or other tools for machining. In order to provide the cutter with the cooling effect, some collets are designed to have pathways for coolants flowing therewithin and for cooling the cutters fixed to the collets to reduce the temperature during machining and to reduce the wear of the cutters.

However, a conventional collet of the abovementioned collets only has a single pathway for coolant. The conventional collet directly contacts the cutter with the coolant within the collet or by spraying the coolant to the workpiece from the collet via the only one pathway. Consequently, the conventional collet cannot provide an efficient cooling effect to the cutter.

To overcome the shortcomings of the conventional collet, the present invention provides a collet for cooling a cutter to mitigate or obviate the aforementioned problems.

### SUMMARY OF THE INVENTION

The main objective of the present invention is to provide a collet that can provide various pathways for cooling a cutter and promote the cooling effect to the cutter.

The collet has a collet body, at least one groove, and at least one channel. The collet body has a central axis, a through hole extending along the central axis, a plurality of front slots, and a plurality of rear slots fluidly communicating with said groove and said channel. Each front slot extends from a front end toward a rear end of the collet body. Each rear slot extends from the rear end toward the front end of the collet body. Each groove is defined in an inner surface of the through hole, and extends from the front end toward the rear end of the collet body. Each channel separates from the through hole, extends from the front end toward the rear end of the collet body, and inclines toward the central axis and the front end of the collet body.

In the present invention, said groove and said channel respectively form different pathways for the coolant flowing therewithin. The cutter is cooled at the inside of the collet and at a machining portion contacting a workpiece. Compared with the conventional collet with a singular coolant pathway, the collet of the present invention promotes the cooling effect to the cutter. Wear of the cutter due to thermal fatigue is reduced, service life of the cutter is prolonged, and expense of repairing the cutter and cost of the manufacture are reduced accordingly.

Other objects, advantages, and novel features of the invention will become more apparent from the following detailed description when taken in conjunction with the accompanying drawings.

### BRIEF DESCRIPTION OF THE DRAWINGS

FIG. 1 is a perspective view of a first embodiment of a collet in accordance with the present invention;

FIG. 2 is a front view of the collet in FIG. 1;

FIG. 3 is a cross-sectional side view of the collet across line 3-3 in FIG. 2;

FIG. 4 is a perspective view showing a spindle assembled with the collet in FIG. 1;

FIG. 5 is a cross-sectional side view of the spindle assembled with the collet in FIG. 4;

FIG. 6 is a perspective view of a second embodiment of the collet in accordance with the present invention;

FIG. 7 is a front view of the collet in FIG. 6; and

FIG. 8 is a cross-sectional side view of the collet across line 8-8 in FIG. 7.

### DETAILED DESCRIPTION OF PREFERRED EMBODIMENTS

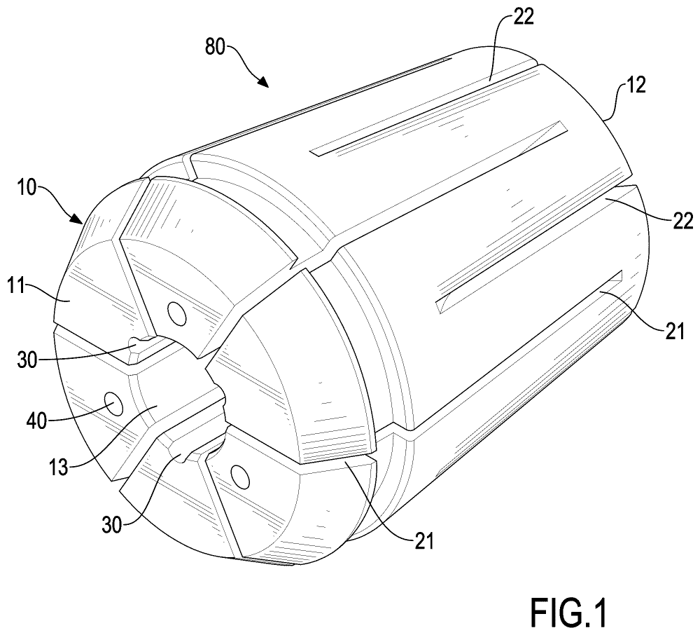

With reference to FIG. 1, a first embodiment of a collet 80 in accordance with the present invention has a collet body 10, a plurality of slots, a plurality of grooves 30, and a plurality of channels 40. The plurality of slots, the plurality of grooves 30, and the plurality of channels 40 are formed at the collet body 10 by machining.

With reference to FIGS. 1 to 3, the collet body 10 has a central axis C, a front end 11, and a rear end 12. The front end 11 and the rear end 12 are opposite to each other along the central axis C. A cutter may be connected within the collet body 10 via the front end 11 of the collet body 10. The rear end 12 of the collet body 10 may be connected to a cutter holder to be assembled to a spindle. The collet body 10 further has a through hole 13 extending to the front end 11 and the rear end 12 along the central axis C for receiving the cutter.

With reference to FIGS. 1 to 3, the plurality of slots separate from one another. Each slot is defined through a periphery of the collet body 10 and extends to the through hole 13. The plurality of slots can be distinguished into a plurality of front slots 21 and a plurality of rear slots 22. Each front slot 21 extends from the front end 11 toward the rear end 12 of the collet body 10. Each rear slot 22 extends from the rear end 12 toward the front end 11 of the collet body 10.

Specifically, the collet 80 is an elastic collet. The plurality of the front slots 21 and the plurality of the rear slots 22 extending to the through hole 13 of the collet body 10 provide the collet body 10 with deformability, when the cutter is assembled to or detached from the through hole 13 of the collet body 10. After the cutter is inserted in the through hole 13, a collet nut is adapted to press the collet body 10, and the collet body 10 deforms to clamp the cutter. Therefore, the cutter is fixed and free from being detached.

Wherein, the collet body 10 has two conical structures. One of the two conical structures tapers toward the front end 11 of the collet 10 and can deform with the cooperation of the plurality of the front slots 21. The other one of the two conical structures tapers toward the rear end 12 of the collet body 10 and can deform with the cooperation of the plurality of the rear slots 22. The collet nut and the cutter holder have respective pits to press the two conical structures respectively for clamping the cutter by the collet body 10.

With reference to FIGS. 1 to 3, the plurality of the grooves 30 are arranged around the through hole 13. Each groove 30 is defined in an inner surface of the through hole 13, extends from the front end 11 toward the rear end 12 of the collet body 10, and fluidly communicates with a corresponding one of the rear slots 22. The groove 30 and the rear slots 22 fluidly communicating with each other form a pathway for a coolant flowing therewithin. The grooves 30 fluidly communicating with the rear slots 22 separate from the plurality of the front slots 21.

With reference to FIGS. 1 to 3, the plurality of the channels 40 are arranged around the through hole 13 as well. Each channel 40 separates from the through hole 13 and the plurality of grooves 30. Each channel 40 extends from the front end 11 toward the rear end 12 of the collet body 10, fluidly communicates with a corresponding one of the rear slots 22, and gradually inclines toward the central axis C and the front end 11 of the collet body 10 to form another pathway for the coolant flowing therewithin. The channels 40 fluidly communicating with the rear slots 22 separate from the plurality of the front slots 21 as well.

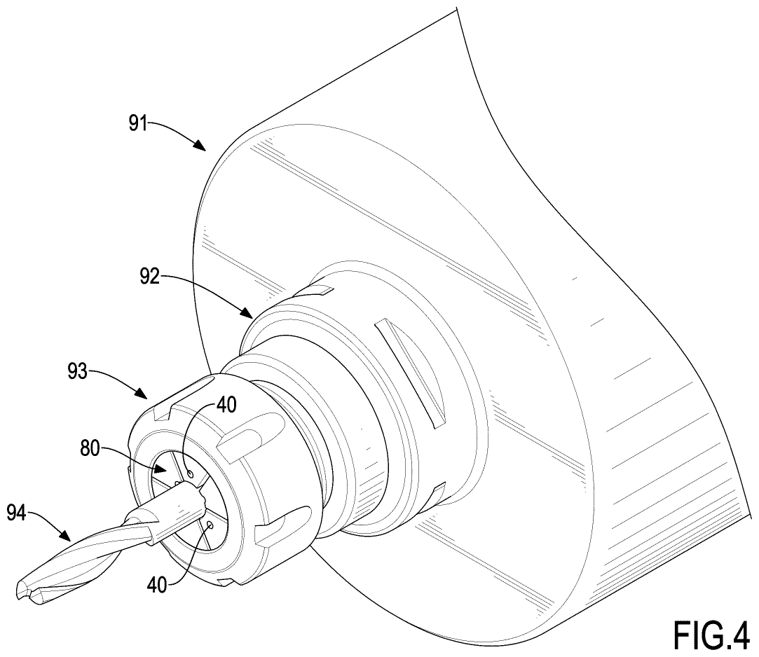

With reference to FIG. 4, when the collet 80 of the present invention is adapted to a spindle structure, the collet 80 is assembled and fixed to a cutter holder 92, and the cutter 94 is fixed in the through hole 13 of the collet 80 via a collet nut 93. Then, the cutter holder 92 is fixed to a spindle 91. The cutter 94 can be driven by the spindle 91 to spin with the spindle 91 for machining.

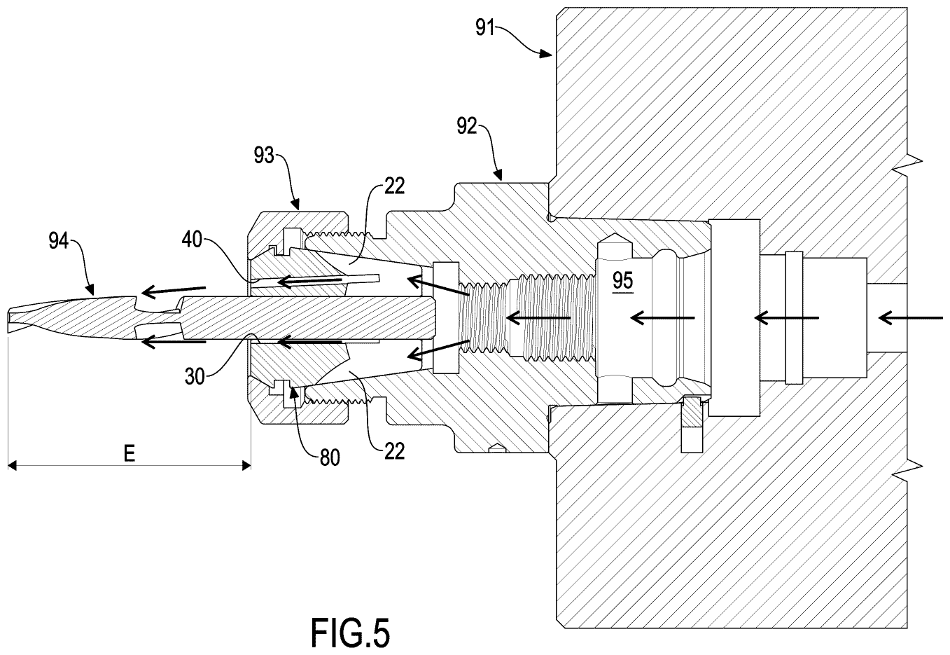

With reference to FIG. 5, the cutter holder 92 has a coolant channel 95 axially disposed therein for cooperating with the collet 80. While machining, the coolant can be conducted from an flow path within the spindle 91 into the coolant channel 95 of the cutter holder 92. Then the coolant enters the plurality of the rear slots 22 extending from the rear end 12 of the collet body 10, the plurality of the grooves 30, and the channels 40 respectively to perform various cooling effects.

Wherein, the coolant, from the rear slots 22, flowing through the plurality of grooves 30 defined in the inner surface of the through hole 13 prolongs a contact time between the coolant, an inside of the collet 80, and the cutter 94 for cooling the collet body 10 and part of the cutter 94 inside the collet 80. The coolant passing through the grooves 30 is sprayed to a workpiece from the front end 11 of the collet body 10.

When the coolant flows into the plurality of the channels 40 separating from the through hole and the plurality of the grooves 30, it flows along the pathway free from contacting the cutter 94. The coolant is sprayed from the front end 11 of the collet body 10 after passing through the channels 40. Since each channel 40 inclines toward the central axis C of the collet body 10 and the front end 11 of the collet body 10, the coolant out from the channels 40 is sprayed to a machining portion where the cutter 94 contacts the workpiece and generates heat by friction for directly cooling the machining portion.

Therefore, the grooves 30 and the channels 40 respectively form the different pathways for the coolant flowing therewithin. The cutter 94 is cooled at the inside of the collet 80 and at the machining portion contacting the workpiece. Compared with the conventional collet with a singular coolant pathway, the collet of the present invention promotes the cooling effect to the cutter 94. Wear of the cutter 94 due to thermal fatigue is reduced, service life of the cutter 94 is prolonged, and expense of repairing the cutter 94 and cost of the maintenance are reduced accordingly.

In the first embodiment of the present invention, the collet 80 has the plurality of grooves 30 and the plurality of channels 40. Specifically, the collet 80 has three said grooves 30 and three said channels 40. In other embodiments, the different pathways of the coolant for promoting the cooling effect can be formed by a singular said groove 30 and a singular said channel 40. The specific amounts of the grooves 30 and the channels 40 can be determined by a length and an outer diameter of the collet body 10, by the amounts of the rear slots 22, and by a diameter of the through hole 13 to achieve an optimal cooling effect.

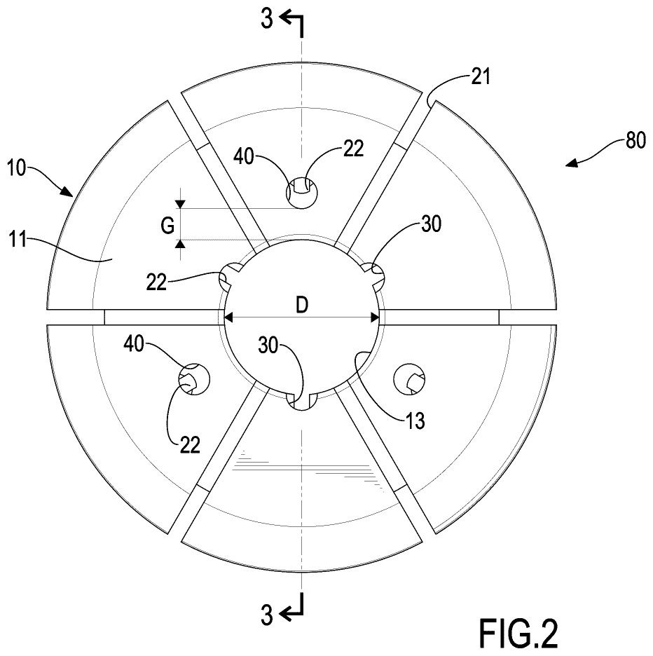

In addition, in FIG. 2, the plurality of the grooves 30 are arranged around the through hole 13 at equiangular intervals to evenly cool the cutter 94 and the collet body 10 from the inside of the collet 80. The plurality of the channels 40 are arranged around the through hole 13 at equiangular intervals as well, and the coolant out from the front end 11 of the collet body 10 is sprayed to the machining portion where the cutter 94 contacts the workpiece via various angles to acquire a better cooling effect.

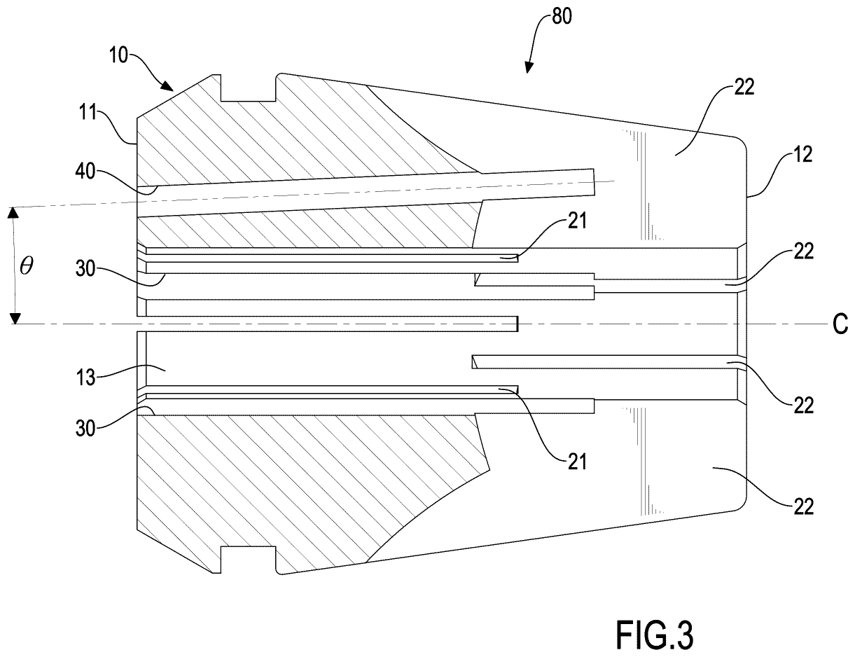

Meanwhile, in the first embodiment of the present invention shown in FIG. 2, a shortest distance G is defined between the inner surface of the through hole 13 and an inner surface of each channel 40. The through hole 13 has a diameter D. With reference to FIG. 3, an included angle θ is defined between the central axis C of the collet body 10 and each channel 40 that inclines toward the central axis C and the front end 11 of the collet body 10. The tangent value of the included angle θ is equal to the shortest distance G divided by four times the diameter D as

$$tan θ = \frac{G}{4 D} .$$

Specifically, with reference to FIG. 5, after the cutter 94 is assembled in the through hole 13 of the collet 80, an extending distance E is defined as a length of a section of the cutter 94 that protrudes from the front end 11 of the collet body 10. The extending distance E is substantially four times a diameter of the cutter 94 and is four times the diameter D of the through hole 13 as well. Thereby, the cutter 94 is free from shaking because of the extending distance E being too long. The workpiece is free from colliding with the collet nut 93 or other components of the spindle structure because of the extending distance E being too short.

In the first embodiment of the present invention, a specific angle is assigned to the included angle θ to make the tangent value of the included angle θ equal to the shortest distance G divided by four times the diameter D. When the coolant is sprayed from the front end 11 of the collet body 10 via the channels 40, the coolant can indeed be sprayed to a machining portion where a tip of the cutter 94 contacts the workpiece to achieve an optimal cooling effect.

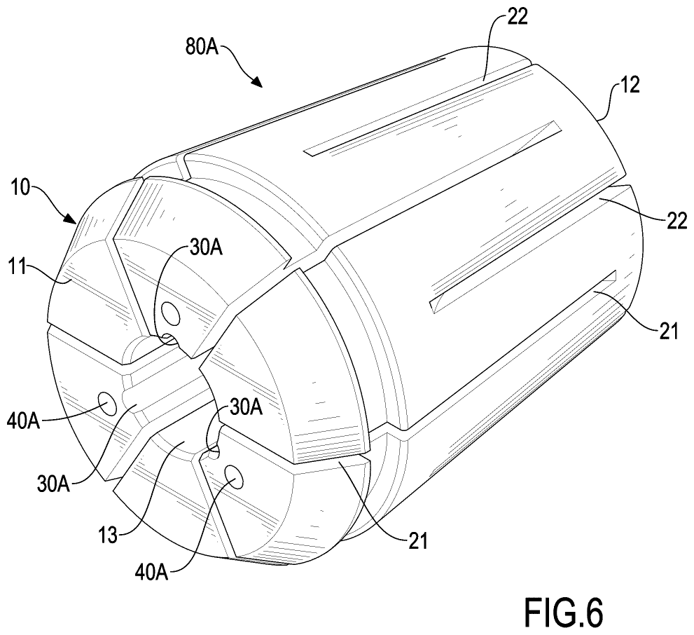

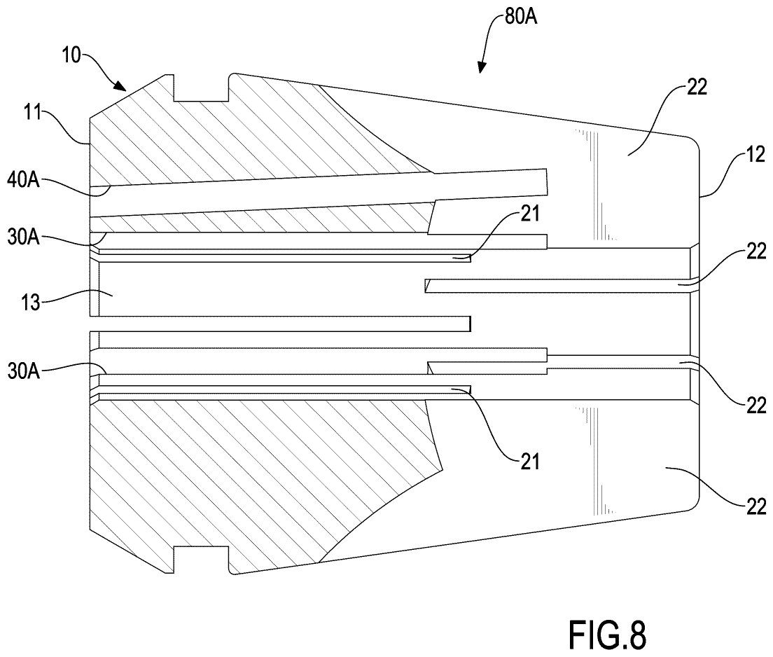

With reference to FIGS. 6 to 8, a second embodiment of the collet 80A in accordance with the present invention has been shown. In the first embodiment of the present invention, the plurality of grooves 30 and the plurality of channels 40 around the through hole 13 are misaligned with one another. The difference between the second embodiment and the first embodiment is that in the second embodiment shown in FIG. 8, each groove 30A fluidly communicates with a corresponding one of the channels 40A via a corresponding one of the rear slots 22.

With reference to FIG. 2, in the first embodiment of the present invention, the plurality of the grooves 30 around the through hole 13 and the plurality of the channels 40 are misaligned with one another. Consequently, the plurality of grooves 30 and the plurality of channels 40 radially orient in different directions. Since the grooves 30 and the channels 40 are formed in different radial directions by machining, the portion around the through hole 13 is rigid and free from diminishing structural strength caused by over machining.

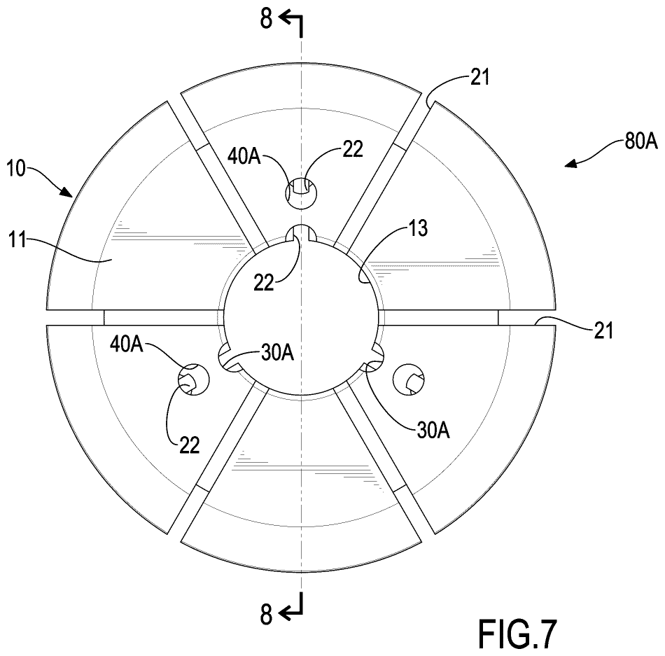

With reference to FIG. 7, in the second embodiment of the present invention, each groove 30A fluidly communicates with the corresponding one of the channels 40A via the corresponding one of the rear slots 22. Each groove 30A and its corresponding channel 40A are located in a same radial direction of the through hole 13. Therefore, each channel 40A and the through hole 13 separate by the corresponding groove 30A. Heat transmitted to the channels 40A from the cutter 94 via the collet body 10 is reduced, coolant sprayed to the machining portion via the channels 40A is kept at a low temperature, and a better cooling effect is achieved.

Wherein, the material and the size of the collet 80, the amounts of the front slots 21 and the rear slots 22, and other data can be considered to determine whether the first embodiment or the second embodiment is adapted to achieve a proper rigidity of the collet 80 and a suitable cooling effect.

In addition, in the first and the second embodiments, each groove 30/30A and each channel 40/40A fluidly communicate with the corresponding rear slot 22. In other embodiments, each groove 30/30A and each channel 40/40A may fluidly communicate with two or more rear slots 22 when the rear slots 22 are in a large amount and are arranged densely.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A collet comprising:
a collet body having
a central axis;
a through hole extending along the central axis;
a plurality of front slots, each front slot extending from a front end of the collet body toward a rear end of the collet body; and
a plurality of rear slots, each rear slot extending from the rear end of the collet body toward the front end of the collet body;
at least one groove fluidly communicating with the plurality of rear slots, each groove defined in an inner surface of the through hole, and extending from the front end of the collet body toward the rear end of the collet body; and
at least one channel fluidly communicating with the plurality of rear slots, each channel separating from the through hole, extending from the front end of the collet body toward the rear end of the collet body, and inclining toward the central axis and the front end of the collet body.

2. The collet as claimed in claim 1, wherein the collet has
a plurality of said grooves arranged around the through hole, each said groove fluidly communicating with a corresponding one of the plurality of rear slots; and
a plurality of said channels arranged around the through hole, each said channel fluidly communicating with a corresponding one of the plurality of rear slots.

3. The collet as claimed in claim 2, wherein the plurality of grooves and the plurality of channels around the through hole are misaligned with one another.

4. The collet as claimed in claim 2, wherein each groove fluidly communicates with a corresponding one of the plurality of channels via the corresponding one of the plurality of rear slots fluidly communicating with the groove.

5. The collet as claimed in claim 2, wherein the plurality of grooves are arranged around the through hole at equiangular intervals.

6. The collet as claimed in claim 3, wherein the plurality of grooves are arranged around the through hole at equiangular intervals.

7. The collet as claimed in claim 4, wherein the plurality of grooves are arranged around the through hole at equiangular intervals.

8. The collet as claimed in claim 2, wherein the plurality of channels are arranged around the through hole at equiangular intervals.

9. The collet as claimed in claim 3, wherein the plurality of channels are arranged around the through hole at equiangular intervals.

10. The collet as claimed in claim 4, wherein the plurality of channels are arranged around the through hole at equiangular intervals.

11. The collet as claimed in claim 1, wherein
a shortest distance is defined between the inner surface of the through hole and an inner surface of each channel;
the through hole has a diameter;
an included angle is defined between the central axis of the collet body and each channel that inclines toward the central axis and the front end of the collet body; and
the tangent value of the included angle is equal to the shortest distance divided by four times the diameter of the through hole.

12. The collet as claimed in claim 2, wherein
a shortest distance is defined between the inner surface of the through hole and an inner surface of each channel;
the through hole has a diameter;
an included angle is defined between the central axis of the collet body and each channel that inclines toward the central axis and the front end of the collet body; and
the tangent value of the included angle is equal to the shortest distance divided by four times the diameter of the through hole.

13. The collet as claimed in claim 3, wherein
a shortest distance is defined between the inner surface of the through hole and an inner surface of each channel;
the through hole has a diameter;
an included angle is defined between the central axis of the collet body and each channel that inclines toward the central axis and the front end of the collet body; and
the tangent value of the included angle is equal to the shortest distance divided by four times the diameter of the through hole.

14. The collet as claimed in claim 4, wherein
a shortest distance is defined between the inner surface of the through hole and an inner surface of each channel;
the through hole has a diameter;
an included angle is defined between the central axis of the collet body and each channel that inclines toward the central axis and the front end of the collet body; and
the tangent value of the included angle is equal to the shortest distance divided by four times the diameter of the through hole.
